(19) United States
(12) Patent Application Publication
(10) Pub. No.: US 2023/0191495 A1
(43) Pub. Date: Jun. 22, 2023

(54) METHODS OF FORMING A MULTI-PRINCIPAL ELEMENT ALLOYL

(71) Applicant: Battelle Energy Alliance, LLC, Idaho Falls, ID (US)

(72) Inventors: Calvin Downey, Idaho Falls, ID (US); Isabella J. van Rooyen, Idaho Falls, ID (US); Luis Nunez, Idaho Falls, ID (US)

(21) Appl. No.: 18/069,023

(22) Filed: Dec. 20, 2022

Related U.S. Application Data
(60) Provisional application No. 63/292,121, filed on Dec. 21, 2021.

(51) Int. Cl. B22F 12/58; C22C 30/00; B22F 10/28; B22F 12/57; B22F 10/30; B33Y 10/00; B33Y 50/02

(52) U.S. Cl. CPC B22F 12/58; C22C 30/00; B22F 10/28; B22F 12/57; B22F 10/30; B33Y 10/00; B33Y 50/02

(57) ABSTRACT

A method of forming a multi-principal element alloy may include selecting a targeted composition, the targeted composition defining two or more elements and their respective proportions, determining a theoretical relative feed rate of two or more feedstock materials, determining a series of feedstock relative feed rates based on the theoretical relative feed rate, each member of the series defining a relative feed rate of the feedstock materials, forming a functionally graded material article in a directed energy deposition test process by successively matching a test deposition relative feed rate to each member of the series of feedstock relative feed rates, analyzing the functionally graded material article to determine a empirical feedstock relative feed rate of the series of feedstock relative feed rates, and forming the multi-principal element alloy in a directed energy deposition production process by matching a production deposition relative feed rate to the empirical feedstock relative feed rate.

### CROSS-REFERENCE TO RELATED APPLICATION

This application claims the benefit, under 35 U.S.C. § 119(e), of U.S. Provisional Patent Application Ser. No. 63/292,121, filed Dec. 21, 2021, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to systems and methods of forming an alloy. More particularly, the disclosure relates to methods of forming a multi-principal element alloy and related systems.

BACKGROUND

In recent years, multi-principal element alloys have been gaining in prominence in manufacturing industries. Multi-principal element alloys are a type of alloy that includes several principal elements, including one or more metals. Multi-principal element alloys may further include one or more secondary elements in lower proportions than the principal elements. In some cases, the principal elements of the multi-principal element alloy are approximately equiatomic with each other. Multi-principal element alloys may also be known in the art as “high-entropy alloys” or “complex concentrated alloys.” The multi-principal element alloy may be formed by plasma arc melting or other conventional techniques that use pure metals or customized/pre-alloyed materials. Many multi-principal element alloys may include complex repeating crystalline lattice structures. Such structures may impart higher strength, stability at high temperatures, durability/wear resistance, radiation resistance, corrosion resistance, increased ductility, lower thermal conductivity, and/or other preferable physical characteristics in comparison to conventional metals and metal alloys having simple lattice structures.

The multi-principal element alloys may be more expensive to produce than conventional materials due to the cost of manufacturing of pure metal and prealloyed powders as well as a lack of a sustainable supply chain. Prealloyed multi-principal element powders may conventionally be manufactured via gas atomization, which may itself constitute a relatively costly process. Multi-principal element alloys may present further difficulties in forming and/or machining into desirable shapes due to the materials' hardness, the complexity of manufacturing, the overall cost of fabrication, and the lack of repeatability of the materials' microstructure and resulting properties. There may also be material handling and industrial hygiene safety concerns with many pure metal powders that are used to form multi-principal element alloys.

### BRIEF SUMMARY

In accordance with embodiments of the disclosure, a method for forming a multi-principal element alloy comprises selecting a targeted composition, determining a theoretical relative feed rate of two or more feedstock materials, determining a series of feedstock relative feed rates, forming a functionally graded material article, analyzing the functionally graded material article, and forming the multi-principal element alloy. The targeted composition includes two or more metal elements and respective proportions of the two or more metal elements. The theoretical relative feed rate is based on the targeted composition. The two or more feedstock materials include respective metal elements of the targeted composition. The series of feedstock relative feed rates is based on the theoretical relative feed rate. The series of feedstock relative feed rates has multiple members. Each member of the series of feedstock relative feed rates defines a respective relative feed rate of the two or more feedstock materials. The functionally graded material article is formed in a directed energy deposition apparatus. The functionally graded material article is formed by successively matching a test deposition relative feed rate to individual members of the series of feedstock relative feed rates. The functionally graded material article is analyzed to determine an empirical feedstock relative feed rate of the series of feedstock relative feed rates. The multi-principal element alloy is formed in a directed energy deposition production process. The multi-principal element alloy is formed by matching a production deposition relative feed rate to the empirical feedstock relative feed rate.

Further, in accordance with embodiments of the disclosure, a method for forming an article comprises selecting a targeted equiatomic multi-principal element alloy composition, selecting a ratio of feedstock alloys, depositing the feedstock alloys into a melt pool formed by a directed energy deposition process, and mixing the feedstock alloys on a substrate to form the article. The ratio of feedstock alloys is substantially proportionally equivalent to the targeted equiatomic multi-principal element alloy composition. Each of the feedstock alloys includes one or more elements of the multi-principal element alloy. The feedstock alloys are deposited into the melt pool at the selected ratio. The article has substantially the same chemical composition as the targeted equiatomic multi-principal element alloy composition.

Additionally, in accordance with embodiments of the disclosure, a method for forming an article comprises selecting a set of chemical elements that jointly constitute a multi-principal element alloy, determining two or more feedstock materials jointly comprising the set of chemical elements, selecting respective proportions of the set of chemical elements in the multi-principal element alloy, determining respective amounts of the two or more feedstock materials approximately jointly exhibiting the respective proportions of the set of chemical elements in the multi-principal element alloy, and forming, via an additive manufacturing process, the article comprising a chemical composition of the multi-principal element alloy by mixing in situ in a directed energy deposition apparatus the two or more feedstock materials in the respective amounts.

### BRIEF DESCRIPTION OF THE DRAWINGS

FIG. 1 is a simplified, perspective view of a directed energy deposition manufacturing apparatus in accordance with embodiments of the disclosure.

FIG. 2A is a simplified, perspective view of an article having distinct layers, formed in accordance with embodiments of the disclosure.

FIG. 2B is a simplified, perspective view of an article having graded layers, formed in accordance with embodiments of the disclosure.

FIG. 2C is a simplified, perspective view of a homogeneous article, formed in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, or system. Variations from the shapes depicted in the drawings as a result, for example, of manufacturing techniques and/or tolerances, are to be expected. Thus, embodiments described herein are not to be construed as being limited to the particular shapes. The drawings are not necessarily to scale.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 80.0 percent to 120.0 percent of the numerical value, such as within a range of from 90.0 percent to 110.0 percent of the numerical value, within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, a composition of a multi-principal element alloy is described as a percentage of one or more principal elements making up the alloy. The composition of the multi-principal element alloy may additionally be described as a percentage of one or more secondary elements making up the alloy. In this context, the percentage is an atomic percentage (at. %) of the respective element as part of the alloy. For example, reference to a CoCrFeNi multi-principal element alloy comprising approximately 25 at. % cobalt means that the quantity of cobalt atoms in the alloy makes up approximately 25% of the total atoms present in the alloy.

As used herein, a composition of a feedstock material is described as a percentage value of one or more elements making up the alloy. In this context, the percentage is a weight percentage (wt %) of the respective element as part of the alloy. Further, a relative feed rate for the one or more feedstock materials is provided as a percentage. In this context, the relative feed rate refers to a weight percentage of the respective feedstock material as part of the combined feed rates for all feedstock materials. For example, reference to a 33.3 wt % relative feed rate of SS316L means that the relative feed rate of 316L stainless steel is 33.3% (as a weight percentage) of the combined feed rate of all feedstock materials.

As used herein, the term “equiatomic” in reference to a given alloy means that the principal metal elements make up equal respective percentages of the alloy. The term “approximately equiatomic” in reference to a given alloy means that the principal elements in the make up approximately equal respective percentages of the alloy. For example, an approximately equiatomic composition in reference to a nominal numerical percentage may include a percentage range from 80.0 percent to 120.0 percent of the nominal numerical percentage value, such as within a range of from 90.0 percent to 110.0 percent of the nominal numerical percentage value, within a range of from 95.0 percent to 105.0 percent of the nominal numerical percentage value, within a range of from 97.5 percent to 102.5 percent of the nominal numerical percentage value, within a range of from 99.0 percent to 101.0 percent of the nominal numerical percentage value, within a range of from 99.5 percent to 100.5 percent of the nominal numerical percentage value, or within a range of from 99.9 percent to 100.1 percent of the nominal numerical percentage value.

As used herein, the term “multi-principal element alloy” means an alloy that includes more than one principal element, including one or more metals, wherein each principal element constitutes a significant proportion (e.g., at least 10 at. %, such as at least 15 at. %, at least 20 at. %, at least 25 at. %) of the alloy. In some embodiments, the quantity of principal elements in a multi-principal element alloy is at least two principal elements, such as least three principal elements, such as at least four principal elements. Metal alloys having only one principal element, not including secondary elements, are excluded from the scope of the disclosure. A multi-principal element alloy may include one or more secondary elements, wherein each secondary element constitutes a proportion substantially less than the respective proportions of the principal elements (e.g., less than 10 at. % of the multi-principal element alloy, such as less than 5 at. %, less than 3 at. %).

In this disclosure, approximate atomic percentages of principal elements in an alloy may be given as a subscript number following the respective symbol for that chemical element. For example, a multi-principal element alloy designated as Co₂₅Cr₂₅Fe₂₅Ni₂₅ includes approximately 25% each of cobalt, chromium, iron, and nickel; moreover, Co₂₅Cr₂₅Fe₂₅Ni₂₅ may be considered an equiatomic multi-principal element alloy, with each principal element comprising approximately 25% of the alloy.

As used herein, a “targeted composition” refers to a chemical composition of the multi-principal element alloy and/or an object (e.g., an article) to be formed from the multi-principal element alloy, with reference to a desired composition in a formed alloy and/or article. The targeted composition may include multiple principal elements and their respective proportions in the alloy or article. In some cases, an actual, realized alloy and/or article may not have the exact targeted composition; however, the actual composition may be approximately close to the targeted composition in terms of respective element proportions, microstructure, and other material parameters.

The principal elements (e.g., the metal element, the principal element) of the multi-principal element alloy may include, but are not limited to, one or more of Co, Cr, Fe, Ni, Al, Ti, and Mn. Additionally, some embodiments of the multi-principal element alloy may include approximately 1-5 at. % of B, Mo, Mb, Mn, Si, Ti, C, V, Hf, Nb, Zr, Ta, and/or W as secondary elements.

According to embodiments of the disclosure, the multi-principal element alloy may be formed by combining, in predetermined ratios, the feedstock materials (e.g., powder feedstock materials). The feedstock materials are proportioned to jointly combine into the multi-principal element alloy with a desirable composition (e.g., the targeted composition) of elements.

The multi-principal element alloy may be formed by an additive manufacturing (AM) process that allows tailoring of the chemical composition and the microstructure. In some embodiments, the multi-principal element alloy has an equiatomic composition. However, depending on the targeted composition, it may be difficult and expensive to achieve exact equiatomic compositions, and variations from exact equiatomic ratios may result in acceptable qualities of the resultant alloy. Thus, embodiments of the disclosure may also include forming the multi-principal element alloy that has a composition approximately equal to the targeted composition.

The multi-principal element alloy may include, but is not limited to, CoFeMnMo, CoCrFeMn, CrFeMnMo, CoCrMnMo, CoCrFeMo, FeMnMoV, CoFeMnNi, CrFeMnV, CrMnMoNb, CrMnMoV, CrFeMoV, CoCrMnNi, CoCrFeNi, HfMoNbZr, FeNiMnCr, FeCoCrNi, FeNiCrCoMoNbMn, TiZrNbTaFe, AlFeVSi, FeCoNiCrTi, FeCoNiCrAl, and FeCoNiCrCu. Examples of the multi-principal element alloy, including illustrative atomic percentage values, include Fe₂₀Ni₂₄Cr₂₂Co₂₆Mo₄Nb₂Mn₁, Fe₃₂Ni₂₀Cr₂₂Co₂₀Mo₄Nb₁Mn₁, Fe₄₁Ni₁₈Cr₂₁Co₁₅Mo₃Nb₁Mn₁, and Fe₅₄Ni₁₅Cr₁₉Co₈Mo₂Nb₁Mn₁.

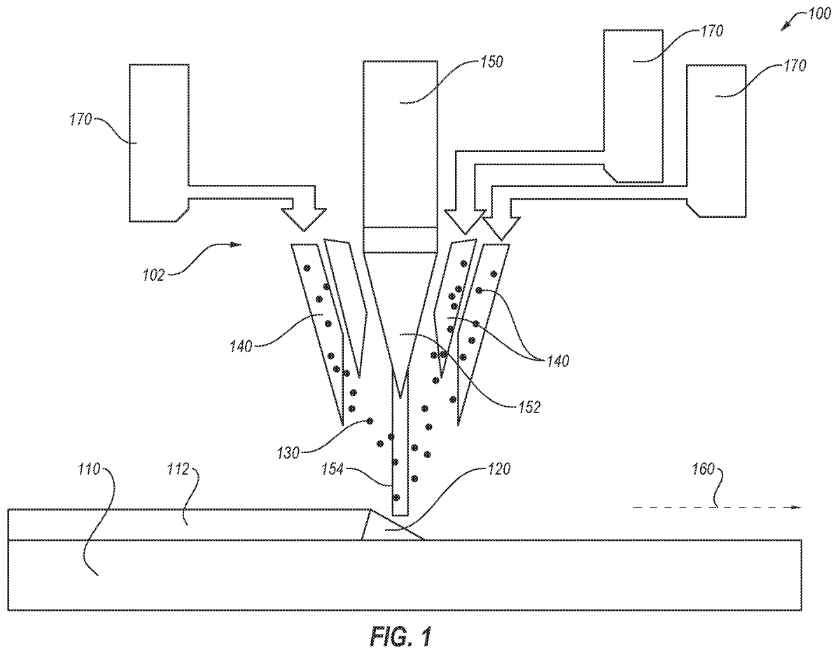

The AM process for forming the multi-principal element alloy may be a directed energy deposition (DED) process according to methods of the disclosure. For example, the process may be a “blown powder directed energy deposition” process. Forming a multi-principal element alloy according to the disclosure may involve mixing in situ two or more of the powder feedstock materials in a directed energy deposition apparatus, where the individual powder feedstock materials comprise one or more elements (e.g., a pure metal, a metal alloy) of the targeted composition. Referring to FIG. 1, a directed energy deposition apparatus 100 may function by directing an energy source to a substrate 110. Energy (e.g., heat) from the energy source may form a melt pool 120 of the substrate 110 on its surface, while powder feedstock materials 130 are continuously deposited (e.g., injected) into the melt pool 120 from nozzles 140 of a deposition head 102. In the embodiment depicted in FIG. 1, the energy source of the directed energy deposition apparatus 100 comprises a laser source 150 and focal lens 152, which may produce a focused laser beam 154 directed at the substrate 110. The directed energy deposition apparatus 100 may include multiple feeders 170 that contain the powder feedstock materials 130, with each feeder 170 including one of the powder feedstock materials 130. For example, one of the feeders 170 may include a pure metal powder, another of the feeders 170 may include a different pure metal powder, and another of the feeders 170 may include a metal alloy powder. The feeders 170 may be independently controllable, such that the relative feed rates of the powder feedstock materials 130 may be independently selected. The directed energy deposition apparatus 100 may, for example, be a laser-engineered-net-shaping (LENS) apparatus.

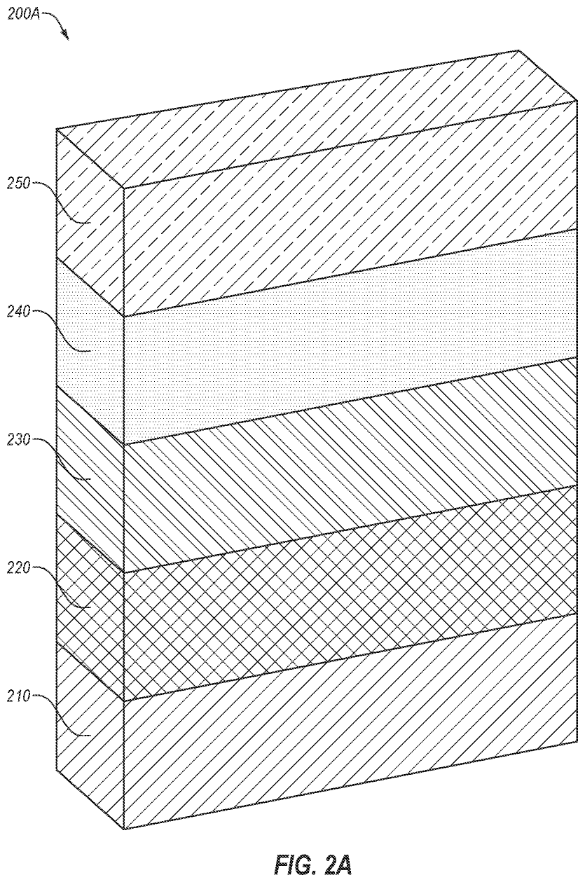

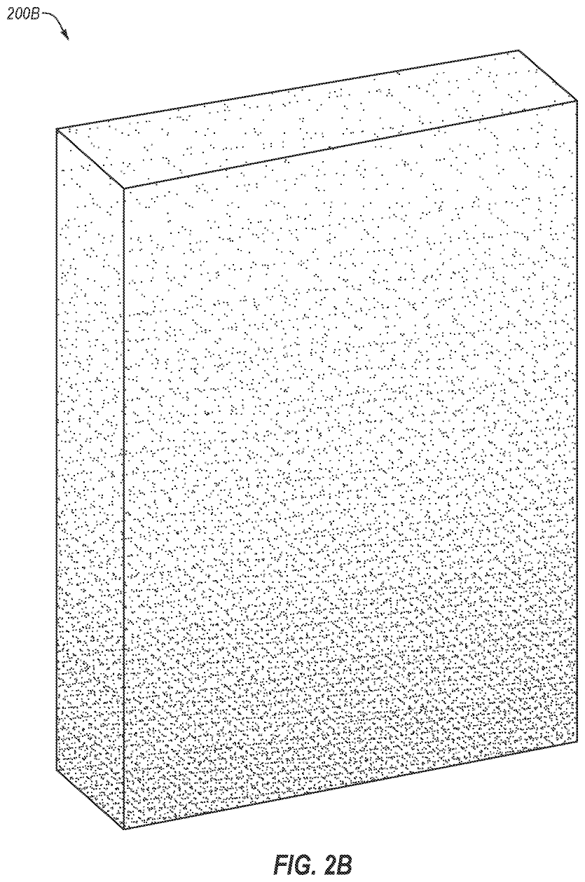

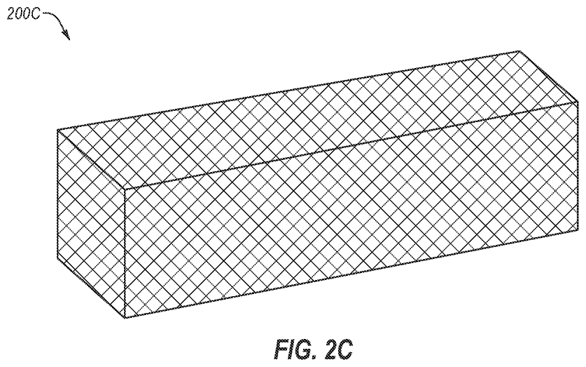

During use and operation, the deposition head 102 of the directed energy deposition apparatus 100 may move laterally along a movement path 160 relative to the substrate 110, extending the melt pool 120 along the surface of the substrate 110. As the deposition head 102 moves, the powder feedstock materials 130 in the melt pool 120 may solidify, developing a clad of deposited material 112 over the substrate 110. Following formation of the deposited material 112, the deposition head 102 may pass a subsequent time along the movement path 160, with the deposited material 112 acting as the substrate 110 for a subsequent stratum of material to be deposited on the deposited material 112. Using the AM process, repeated passes of the deposition head 102 may form numerous strata (e.g., layers) of material, deposited one over another, until a desired material thickness of an article (see FIG. 2) is reached. The article may include a homogeneous composition of the multi-principal element alloy or may include a heterogeneous composition of the multi-principal element alloy. In other words, substantially all of the article may include a single chemical composition, portions of the article may include different chemical compositions, or the article may include a gradient of the chemical composition. The DED process may be used to form the article exhibiting a simple geometry or a more complex geometry. Therefore, the DED process may be used to produce near net shape articles.

By providing compositional control of a multi-principal element alloy, the DED process may also provide control of the microstructure of the article formed from the multi-principal element alloy. For example, an approximately equiatomic CoCrFeNi multi-principal element alloy may comprise a single phase face-centered cubic (FCC) microstructure exhibiting superior irradiation resistance in comparison to alloys having multiphase or single phase body-centered cubic (BCC) microstructures. Additional secondary elements in such a CoCrFeNi multi-principal element alloy may increase the phase instability of the material, and thus improve high-temperature and irradiation resistance due to formation of a second Cr-rich FCC Sigma (σ) phase in the microstructure. Moreover, addition of secondary elements such as Mn, Si, Mo, Nb, and Ti may increase the equivalent chromium content (ECC) value of the multi-principal element alloy; whereas an ECC over approximately 18% may preferentially form σ phase precipitates. Such precipitation of intermetallic phases due to Mo or Nb may substantially strengthen the multi-principal element alloy without significantly increasing brittleness. Accordingly, the composition and microstructure of a multi-principal alloy, and the resulting properties therefrom, may be tailored and optimized for each application by adding one or more secondary elements to a composition of principal elements.

The directed energy deposition apparatus 100 may be configured to implement a selectable (e.g., adjustable) relative feed rate specific for each powder feedstock material 130, thus enabling the targeted composition of the multi-principal element alloy to be achieved by selecting the relative feed rates for each individual feedstock material. An article including the homogeneous composition of the multi-principal element alloy may be achieved by using constant feed rates of the powder feedstock materials 130 as the deposition progresses. An article including a heterogeneous composition of the multi-principal element alloy may be achieved by varying the feed rates of the powder feedstock materials 130 over the course of the deposition process. By altering the feed rates of the individual feedstock materials relative to one another, the article may be a functionally graded material. The speed of the deposition head 102 and power of the laser source 150 may also be controlled to adjust the composition and microstructure of the multi-principal element alloy, which determine properties of the multi-principal element alloy, such as yield strength, corrosion resistance, durability, wear resistance, ductility, thermal stability, thermal conductivity, and radiation resistance.

For a given targeted composition of the multi-principal element alloy, specific combinations of two or more commercially available powder feedstock materials 130 may be used to jointly achieve a composition that closely matches the targeted composition. In some embodiments, the powder feedstock materials 130 are commercially available. The elemental composition in the multi-principal element alloy may be controlled by adjusting relative feed rates of the individual feedstock materials, based on desired atomic or mass fractions to be achieved in the targeted composition. As non-limiting examples, commercially available feedstock materials may include, but are not limited to, Co₇₀Cr₃₀, 316L stainless steel (“SS316L”), 384 stainless steel (“SS384”), INCONEL® 718 (“INC718”), and STELLITE® 21 (“STEL21”), pure (100%) cobalt, or pure (100%) manganese. INCONEL® is a registered trademark of Huntington Alloys Corporation of Huntington, W. Va. and STELLITE® is a registered trademark of Kennametal Inc. of Latrobe, Pa. Table 1 shows the composition of potential feedstock materials, including SS316L, SS384, INCONEL® 718 (INC718), and STELLITE® 21 (STEL21). By combining two or more of these feedstock materials at selected ratios, the targeted composition of the resultant alloy may be achieved.

TABLE 1
weight percentage compositions of commercially available alloys.

| Elements | Fe | Ni | Cr | Mo | Co | Mn | Si | Nb | Ti | C |
|---|---|---|---|---|---|---|---|---|---|---|
| SS316L | 62.25 | 14 | 18 | 3 | | 2 | 0.75 | | | 0.03 |
| SS384 | 63 | 18 | 16 | | | 2 | 1 | | | 0.08 |
| INC718 | 14 | 55 | 21 | 3.30 | | | | 5.5 | 1.2 | |
| STEL21 | | | 27 | 5 | 67.8 | | | | | 0.2 |

If, for example, an equiatomic multi-principal element alloy comprising cobalt, chromium, iron, and nickel (e.g., Co₂₅Cr₂₅Fe₂₅Ni₂₅) is the targeted composition, then various combinations of SS316L, SS384, INC718, STEL21, Co₇₀Cr₃₀, pure cobalt, pure manganese, and/or additional feedstock materials may be used within the directed energy deposition apparatus 100 to form an article having a composition of Co25Cr25Fe25Ni25, or having a composition approximately equal to the targeted composition.

Table 2 shows various non-limiting examples of such combinations that may produce CoCrFeNi or CrFeMnNi multi-principal element alloys according to embodiments of the disclosure. Some of the CoCrFeNi alloys may be equiatomic or approximately equiatomic. The resulting compositions depicted in Table 2 may optionally include trace amounts (e.g., less than 3 at. %) of secondary elements (e.g., one or more of molybdenum, manganese, silicon, niobium, titanium, and carbon) not shown. In some embodiments, such additional elements, and the deviations from equiatomic CoCrFeNi alloys in the multi-principal element alloys, may not cause a significant detrimental effect on the mechanical properties of the multi-principal element alloy in comparison to a pure equiatomic composition. In other embodiments, the additional trace elements or the deviations from equiatomic CoCrFeNi alloys may impart beneficial properties to the respective multi-principal element alloy (e.g., increasing the material's yield strength).

TABLE 2
Relative feed rates and calculated resulting multi-principal element alloy compositions.

| | Relative Feed Rate (wt %) | | | | | | | Calculated Composition (at. %) | | | | |
|---|---|---|---|---|---|---|---|---|---|---|---|---|
| | SS316L | SS384 | INC718 | STEL21 | Co₇₀Cr₃₀ | Co | Mn | Co | Cr | Fe | Ni | Mn |
| 1 | 41.7 | | 41.7 | | | | 16.7 | 0.00 | 16.25 | 31.77 | 28.75 | 17.50 |
| 2 | 40.0 | | 40.0 | | | | 20.0 | 0.00 | 15.60 | 30.50 | 27.60 | 20.80 |
| 3 | 36.4 | | 36.4 | | | | 27.3 | 0.00 | 14.18 | 27.73 | 25.09 | 28.00 |
| 4 | 41.7 | | 41.7 | | | 16.7 | | 16.67 | 16.25 | 31.77 | 28.75 | 0.83 |
| 5 | 40.0 | | 40.0 | | | 20.0 | | 20.00 | 15.60 | 30.50 | 27.60 | 0.80 |
| 6 | 36.4 | | 36.4 | | | 27.3 | | 27.27 | 14.18 | 27.73 | 25.09 | 0.73 |
| 7 | 36.4 | | 36.4 | 27.3 | | | | 18.49 | 21.55 | 27.73 | 25.09 | 0.73 |
| 8 | 33.3 | | 33.3 | 33.3 | | | | 22.60 | 22.00 | 25.42 | 23.00 | 0.67 |
| 9 | 31.8 | | 31.8 | 36.3 | | | | 24.62 | 22.22 | 24.28 | 21.97 | 0.64 |
| 10 | 30.8 | | 30.8 | 38.5 | | | | 26.08 | 22.38 | 23.46 | 21.23 | 0.62 |
| 11 | 36.4 | | 36.4 | | 27.3 | | | 19.09 | 22.36 | 27.73 | 25.09 | 0.73 |
| 12 | 33.3 | | 33.3 | | 33.3 | | | 23.33 | 23.00 | 25.42 | 23.00 | 0.67 |
| 13 | 31.8 | | 31.8 | | 36.3 | | | 25.41 | 23.31 | 24.28 | 21.97 | 0.64 |
| 14 | 30.8 | | 30.8 | | 38.5 | | | 26.92 | 23.54 | 23.46 | 21.23 | 0.62 |
| 15 | | 33.3 | 33.3 | 33.3 | | | | 22.60 | 21.33 | 25.67 | 24.33 | 0.67 |
| 16 | | 31.8 | 31.8 | 36.3 | | | | 24.62 | 21.59 | 24.52 | 23.25 | 0.64 |
| 17 | | 33.3 | 33.3 | | 33.3 | | | 23.33 | 22.33 | 25.67 | 24.33 | 0.67 |
| 18 | | 31.8 | 31.8 | | 36.3 | | | 25.41 | 22.68 | 24.52 | 23.25 | 0.64 |

As shown in row 7 of Table 2, one exemplary composition may be formed using the feedstock materials of 36.4 wt % SS316L, 36.4 wt % INC718, and 27.3 wt % STEL21. In this example, the resulting multi-principal element alloy may have a composition of approximately 18.49 at. % cobalt, 21.55 at. % chromium, 27.73 at. % iron, 25.09 at. % nickel, and 0.73 at. % manganese. Another exemplary composition, shown in row 18 of Table 2, is a composition formed using the feedstock materials of 31.8 wt % SS384, 31.8 wt % INC718, and 36.3 wt % Co₇₀Cr₃₀. In this example, the resulting multi-principal element alloy may have a composition of approximately 25.41 at. % cobalt, 22.68 at. % chromium, 24.52 at. % iron, 23.25 at. % nickel, and 0.64 at. % manganese. The relative feed rates of the feedstock materials in Table 2 may individually be referred to as a “theoretical relative feed rates” with reference to the targeted composition. In other words, the theoretical relative feed rates may be formulated by determining the relative amounts of the individual feedstock materials that could jointly approximate the corresponding element proportions of the targeted composition. By using the directed energy deposition apparatus 100 (e.g., the LENS apparatus) and readily available feedstock materials, the targeted composition and the microstructure of the multi-principal element alloy may be achieved. The directed energy deposition apparatus 100 enables parameters of the feedstock materials to be controlled. Therefore, the multi-principal element alloy having the targeted composition may exhibit desired microstructural and thermomechanical properties.

Upon identifying theoretical relative feed rates for a particular targeted composition, a screening method may be carried out to determine empirical relative feed rates for the targeted composition. As will be set forth in further detail below, the empirical relative feed rates may be determined by analyzing a functionally graded material (FGM) article. The FGM article may be formed via progressive application of various feedstock relative feed rates. The applied feedstock relative feed rates may be similar to the theoretical relative feed rates, but varied from layer to layer of the article. After formation of the FGM article, the individual layers may be analyzed to determine the actual composition of each one. The layer(s) exhibiting the preferred composition (e.g., most similar to the targeted composition) may be selected, and the corresponding relative feed rates used to form the selected layer(s) may be identified as the empirical relative feed rate(s) for the targeted composition.

The screening method may include determining a series of feedstock relative feed rates that approximate the theoretical relative feed rates. The series of feedstock relative feed rates may be determined by various techniques. One technique involves selecting one principal element of the theoretical relative feed rates to be varied in wt % while the other principal elements remain relatively constant. The principal element to be varied may be assigned a series of wt % amounts incremented from a starting value (e.g., zero) to a final value (e.g., the wt % value of the theoretical relative feed rate, a wt % value above the theoretical relative feed rate). The series of feedstock relative feed rates may thus comprise a number of relative feed rates where the wt % value for the principal element to be varied progressively increases while the respective wt % values of the other principal elements remain relatively constant. The series of feedstock relative feed rates may be formulated such that the theoretical relative feed rates for one or more of the principal elements falls within the range of the series. In one embodiment, the principal element to be varied may be incremented by a constant wt % (e.g., 3%, 5%).

As a non-limiting example, assume that the theoretical relative feed rate is selected to be that in row 18 of Table 2: 31.8% SS384, 31.8% INC718, and 36.3% Co₇₀Cr₃₀. Assume also that the selected principal element to be varied is Co₇₀Cr₃₀. Referring to Table 3, the series of feedstock relative feed rates may be selected to begin where the wt % of Co₇₀Cr₃₀ is 30.3% (e.g., 6% less than the wt % in the theoretical relative feed rate), with the balance being SS384 and INC718. The series may progress as the wt % of Co₇₀Cr₃₀ is increased stepwise relative to the other principal elements (in wt % values being held constant relative to each other), and continuing until a maximum of 42.3% Co₇₀Cr₃₀ (e.g., 6% more than the wt % in the theoretical relative feed rate) is reached. In this example, the minimum and maximum wt % values of the principal element to be varied (e.g., 30.3% and 42.3%, respectively) were selected approximately equidistant from the wt % of the principal element in the theoretical relative feed rate (e.g., 36.3%). In another example, the series of feedstock relative feed rates is formulated by varying multiple principal elements relative to the other principal elements (e.g., both increasing, both decreasing, and/or one increasing while the other one decreasing). For example, in a multi-principal element comprising four principal elements, two principal elements may be selected to be varied across the series of feedstock relative feed rates, while the other two principal elements may be held constant relative to each other across the series of feedstock relative feed rates.

TABLE 3
Example series of feedstock relative feed rates
by varying Co₇₀Cr₃₀ levels.

| SS384 | INC718 | Co₇₀Cr₃₀ |
|---|---|---|
| 34.9 | 34.9 | 30.3 |
| 33.4 | 33.4 | 33.3 |
| 31.9 | 31.9 | 36.3 |
| 30.4 | 30.4 | 39.3 |
| 28.9 | 28.9 | 42.3 |

Following formulation of the series of feedstock relative feed rates, the functionally graded material article may be formed. FIG. 2 depicts such a functionally graded material article 200A. In the example illustrated in Table 3, the series of feedstock relative feed rates comprises five members, each member of the series defining relative feed rates of the individual feedstocks and corresponding to a respective line in Table 2. As shown in FIG. 2, the functionally graded material article 200A comprises five individual layers (e.g., layers 210, 220, 230, 240, 250), each formed using individual feedstock relative feed rates corresponding to a member of the series of feedstock relative feed rates. The functionally graded material article 200A may be formed by stepwise increasing the relative feed rate of Co₇₀Cr₃₀ as the deposition progresses. Each layer (e.g., layers 210, 220, 230, 240, 250) may exhibit a distinct chemical composition based on the feedstock relative feed rates, indicated by sharp delineations between the layers (e.g., layers 210, 220, 230, 240, 250) and formed by vertically stacking multiple strata of deposited material 112. Referring to FIG. 2B, in another embodiment, a functionally graded material article 200B having a finer gradient in comparison to the functionally graded material article 200A is formed by increasing the wt % of Co₇₀Cr₃₀ in smaller increments between each member in the series of feedstock relative feed rates.

Following formation of the functionally graded material article 200A, 200B, analysis may be carried out on the individual layers (e.g., layers 210, 220, 230, 240, 250) to determine the actual chemical composition and microstructure of each layer (e.g., layers 210, 220, 230, 240, 250). Such analysis may include investigating the material microstructure and interface phases, compositional scoping, thermomechanical property analysis, and other investigations as may be relevant to ascertain the desired properties of the multi-principal element alloy. As non-limiting examples, the functionally graded material article 200A, 200B may be analyzed using a scanning electron microscope (SEM), infrared particle size analysis, X-ray diffraction (XRD) via an X-ray diffractometer, or energy-dispersive X-ray spectroscopy (EDS) via use of a scanning electron microscope coupled with an energy-dispersive X-ray spectrometer.

Following the analysis of the individual layers (e.g., layers 210, 220, 230, 240, 250), one or more layers may be selected as having a composition most similar to the targeted composition or otherwise exhibiting desirable properties. The composition is sufficiently similar to the targeted composition if the composition includes substantially the same chemical elements at approximately the same amounts. The respective compositions of such selected layers may be known as “empirical compositions.” In some embodiments, the empirical composition is identical to the targeted composition. In other embodiments, the empirical composition may be similar to the targeted composition. The relative feed rates used to generate the empirical composition may be referred to as the “empirical relative feed rates.”

It may be the case that none of the layers of the functionally graded material article have a chemical composition sufficiently similar to the targeted composition. In such cases, a subsequent series of feedstock relative feed rates may be formulated, and a subsequent functionally graded material article may be formed according to the subsequent series of feedstock relative feed rates. The subsequent series of feedstock relative feed rates may be formulated with a wider range of wt % values than the first series of feedstock relative feed rates and/or by varying at least one additional principal element of the theoretical relative feed rates. The subsequent functionally graded material article may thus be formed and tested in order to identify desirable empirical relative feed rates. Additional subsequent functionally graded material article may likewise be formed until desirable empirical relative feed rates are identified.

With reference to FIG. 2C, upon identifying empirical relative feed rates, an article 200C comprising the empirical composition may be formed by the AM process as desired. Such an article 200C may be homogeneous in chemical composition and a major portion of such article 200C may be formed using the empirical relative feed rates and/or by applying other processing conditions and parameters as used during formation of the functionally graded material article.

In forming a multi-principal element alloy article 200C, it may be desirable for the article 200C to be homogeneous with respect to all of the principal elements of the multi-principal element alloy. To that end, the respective feedstock materials defined in empirical relative feed rates may be selected to promote such homogeneous mixing. Without limiting the scope of the disclosure, it is theorized that in cases where multiple feedstock materials share one or more principal elements in relatively large amounts, the resulting multi-principal element alloy article 200C may have a higher likelihood of achieving homogeneity. As an example, referring to row 18 of Table 2, the feedstock materials include 31.8% of SS384, 31.8% of INC718, and 36.3% of Co₇₀Cr₃₀. Referring to Table 1, all three of these feedstock materials comprise significant proportions of chromium, and the first two of these three feedstock materials (e.g., SS384 and INC718) respectively comprise significant proportions of iron and nickel. These shared amounts of chromium, iron, and nickel amongst the feedstock materials may encourage homogeneous mixing of the feedstock materials during the directed energy deposition process.

The examples provided above use a laser directed energy deposition apparatus and method. However, other additive manufacturing technologies and concepts may be used to produce the article having the targeted composition. In particular, other types of directed energy deposition apparatuses and processes may be used. In other embodiments, powder bed fusion or atomic diffusion processes may be used. In some embodiments, wire-arc or wire-laser additive manufacturing techniques may be used accordingly, with multiple wire spool feeders taking the place of the multiple feeders 170 of the directed energy deposition apparatus 100, with each wire spool feeder providing a respective feedstock material.

The formation of the multi-principal element alloy according to embodiments of the disclosure may provide advantages over alloys formed by conventional manufacturing techniques and apparatuses. These advantages may include precise parametric and feedstock management, which may ultimately enhance microstructural and compositional control of the article formed from the multi-principal element alloy. The microstructure and chemical composition of the multi-principal element alloy according to embodiments of the disclosure may be achieved by the AM DED process. Further, embodiments of the disclosure may allow the use of commercially available metals or metal alloys as the feedstock materials, which can be obtained via robust supply chains. Since the feedstock materials are commercially available, the feedstock materials do not need to be custom made, leading to lower cost and increased availability of feedstock materials and the resulting multi-principal element alloys and articles. Additionally, the AM DED process may enable the near-net formation of the articles, which may reduce manufacturing steps and material waste, further lowering costs of the multi-principal element alloys and articles. The cost of articles formed according to embodiments of the disclosure may be reduced by about 97% compared to conventional processes of forming similar alloys. The feedstock materials may also be more easily and safely handled compared to feedstock materials used in conventional processes, such as casting or arc melting.

The multi-principal element alloy may be used to form the article for use in a variety of industries, such as in the nuclear, aerospace, or petroleum industries, which have extreme environments. The article may be used in the extreme environments, such as in high temperature environments, corrosive environments, and/or other extreme conditions. The article may be used at a temperature of from about 400° C. to about 650° C. or higher without substantially affecting thermomechanical properties of the article. For instance, the article may be used as a component of a nuclear reactor, such as a light water reactor, since the multi-principal element alloy exhibits desirable thermomechanical properties, is corrosion resistant, is resistant to radiation damage, is resistant to irradiation induced creep, is resistant to swelling, and has low embrittlement when exposed to the extreme conditions of a nuclear reactor environment.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

What is claimed is:

1. A method for forming a multi-principal element alloy, comprising:
selecting a targeted composition, the targeted composition comprising two or more metal elements and respective proportions of the two or more metal elements;
determining, based on the targeted composition, a theoretical relative feed rate of two or more feedstock materials, the two or more feedstock materials comprising respective metal elements of the targeted composition;
determining, based on the theoretical relative feed rate, a series of feedstock relative feed rates comprising multiple members, each member of the series of feedstock relative feed rates defining a respective relative feed rate of the two or more feedstock materials;
in a directed energy deposition apparatus, forming a functionally graded material article by successively matching a test deposition relative feed rate to individual members of the series of feedstock relative feed rates;
analyzing the functionally graded material article to determine an empirical feedstock relative feed rate of the series of feedstock relative feed rates; and
in a directed energy deposition production process, forming the multi-principal element alloy by matching a production deposition relative feed rate to the empirical feedstock relative feed rate.

2. The method of claim 1, wherein forming the multi-principal element alloy in the directed energy deposition production process comprises forming an article exhibiting a homogeneous chemical composition.

3. The method of claim 1, wherein forming the multi-principal element alloy in the directed energy deposition production process comprises in situ mixing the two or more feedstock materials in the production directed energy deposition process.

4. The method of claim 1, wherein determining, based on the theoretical relative feed rate, the series of feedstock relative feed rates comprises varying, across the multiple members of the series of feedstock relative feed rates, a relative feed rate of a selected one feedstock material of the two or more feedstock materials.

5. The method of claim 4, wherein varying, across the multiple members of the series, the relative feed rate of the selected one of the two or more feedstock materials comprises incrementally increasing, across the multiple members of the series of feedstock relative feed rates, the relative feed rate of the selected one of the two or more feedstock materials by a constant weight percentage.

6. The method of claim 1, wherein determining, based on the theoretical relative feed rate, the series of feedstock relative feed rates comprises varying, across the multiple members of the series of feedstock relative feed rates, respective weight percentages of two selected feedstock materials of the two or more feedstock materials relative to others of the two or more feedstock materials.

7. The method of claim 1, wherein determining, based on the targeted composition, the theoretical relative feed rates of two or more feedstock materials further comprises proportioning the respective metal elements of the targeted composition of the two or more feedstock materials to combine into a composition approximating the targeted composition.

8. The method of claim 1, wherein selecting a targeted composition comprises selecting an equiatomic composition.

9. The method of claim 1, wherein determining, based on the targeted composition, the theoretical relative feed rates of two or more feedstock materials further comprises determining the theoretical relative feed rate of a selected a stainless steel alloy.

10. A method for forming an article, comprising:
selecting a targeted equiatomic multi-principal element alloy composition;
selecting a ratio of feedstock alloys substantially proportionally equivalent to the targeted equiatomic multi-principal element alloy composition, each of the feedstock alloys comprising one or more elements of the multi-principal element alloy;
depositing the feedstock alloys, at the selected ratio, into a melt pool formed by a directed energy deposition process;
mixing the feedstock alloys on a substrate to form the article having substantially the same chemical composition as the targeted equiatomic multi-principal element alloy composition.

11. The method of claim 10, wherein selecting the targeted equiatomic multi-principal element alloy composition comprises selecting a composition comprising at least four principal elements.

12. The method of claim 10, wherein depositing the feedstock alloys into the melt pool formed by the directed energy deposition process comprises injecting the feedstock alloys into the melt pool formed by a laser deposition process.

13. The method of claim 10, wherein selecting the ratio of feedstock alloys comprises selecting the feedstock alloys that are not multi-principal element alloys.

14. The method of claim 10, wherein selecting the ratio of feedstock alloys comprises selecting a nickel-containing alloy.

15. A method for forming an article, comprising:
selecting a set of chemical elements that jointly constitute a multi-principal element alloy;
determining two or more feedstock materials jointly comprising the set of chemical elements;
selecting respective proportions of the set of chemical elements in the multi-principal element alloy;
determining respective amounts of the two or more feedstock materials approximately jointly exhibiting the respective proportions of the set of chemical elements in the multi-principal element alloy; and
forming, via an additive manufacturing process, the article comprising a chemical composition of the multi-principal element alloy by mixing in situ in a directed energy deposition apparatus the two or more feedstock materials in the respective amounts.

16. The method of claim 15, wherein determining respective amounts of the two or more feedstock materials further comprises forming, via an additive manufacturing process, a functionally graded material article by progressively varying a relative feed rate of one of the two or more feedstock materials to form multiple layers in the functionally graded material article.

17. The method of claim 16, wherein determining respective amounts of the feedstock materials further comprises analyzing the functionally graded material article to determine respective compositions of the multiple layers by carrying out x-ray diffraction on the functionally graded material article.

18. The method of claim 15, wherein the two or more feedstock materials comprises a chromium-containing alloy and a cobalt-containing alloy.

19. The method of claim 15, wherein forming, via an additive manufacturing process, the article comprises forming the article by a directed energy deposition process.

20. The method of claim 15, wherein the multi-principal element alloy comprises four or more principal elements.
